(19) United States
(12) Patent Application Publication
(10) Pub. No.: US 2010/0249959 A1
(43) Pub. Date: Sep. 30, 2010

(54) Method and system for soccer sports training and management

(76) Inventor: Efrain Salazar, Mexico City (MX)

Correspondence Address: RICK B. YEAGER, ATTORNEY, 10805 MELLOW LANE, AUSTIN, TX, 78759, US

(21) Appl. No.: 12/750,762

(22) Filed: Mar. 31, 2010

Related U.S. Application Data
(60) Provisional application No. 61/164,936, filed on Mar. 31, 2009.

(51) Int. Cl. A63B 69/00; G06F 19/00

(52) U.S. Cl. 700/91; 473/446; 434/251

(57) ABSTRACT

A method of providing integral soccer sports training for youth comprising providing an age-specific training program; an age specific neuropsicomotor development program; and a computer-based sports management system. The computer-based sports management system incorporates a database, administrative functions, and use of mobile field devices by coaches and referees for field data gathering and reporting.

### RELATED APPLICATIONS

This non-provisional patent application is related to U.S. Provisional patent application No. 61/164,936 filed Mar. 31, 2009, and claims priority of that filing date.

### BACKGROUND

1. Field of Invention

The current invention relates to integral youth education and computer-based management systems using sports as a path to achieve it.

2. Background

One of every three inhabitants of this planet is between 5 and 16 years old. Youth development, education and healthy insertion in the productive life is a responsibility of today's society.

Youth however, in a more or less extent, depending on the country of origin, face growing health and integration risks that are important obstacles to their development. Among these health risks we can refer to obesity (that leads to diabetes and cardiovascular problems), smoking, alcoholism, and drugs. On the integration side we can refer to non productive free time that leads to gangs and delinquency, while watching television or play video devices in excess leads to isolation and family/social disintegration.

There is a need for systems which contribute to the integral youth development through sports, starting with soccer, due to its popularity among children all over the world. The current invention addresses that need, The Methodology for the Integral Training of Children and Youth 6-16 Years of Age Through Sports, was developed to achieve, from early age, a balanced sports work, that allows the maximum exponentiation of the physical and intellectual abilities of the young individual, without forcing his natural maturity process.

### SUMMARY OF INVENTION

The current invention is a comprehensive methodology to guide the integral development of youth through sports, which includes the following products which are available in both English and Spanish.

In one embodiment, there are 9 books (1032 pages) designed to be used by coaches, parents and teachers; and an Automated Sports Management System. One book comprises the Methodology philosophy (347 pages). Seven books comprise the Detailed Training Program for each age category (507 pages total). One book comprises the Neuropsicomotor Development Program (178 pages).

An Automated Sports Management System CFITD Techno Manager comprises a Desktop computer module, and a mobile device module (PDA, Blackberry, iPhone, Handheld PC, etc.). CFITD is an abbreviation for Centers for Integral Formation Through Sports in Spanish.

### DESCRIPTION OF FIGURES

FIG. 1 is a schematic of an embodiment of an Automated Sports Management System's subsystems.

FIG. 2 is a chart showing details of an embodiment of the Administration Subsystem of the embodiment of the Automated Sports Management System.

FIG. 3 is a chart showing details an embodiment of a coach's module of the Operations Subsystem of the embodiment of the Automated Sports Management System.

FIG. 4 is a chart showing details an embodiment of a referee's module of the Operations Subsystem of the embodiment of the Automated Sports Management System.

FIG. 5 is a chart showing details an embodiment of a PDN module of the Operations Subsystem of the embodiment of the Automated Sports Management System.

FIG. 6 is a schematic showing the methodology elements of one embodiment of the current invention.

FIG. 7 is a schematic showing the interrelation of the Integral Training Through Sports Program; a Neuropsicomotor Development Program; and an Automated Sports Management System.

### DESCRIPTION OF EMBODIMENT

### CFITD Methodology

The CFITD Methodology philosophy is described in a book comprising six chapters, and is structured with a goal toward facilitating the comprehension of those seeking to teach or practice soccer, in such a way as to guarantee the physical integrity of the sports enthusiast and his/her optimum performance.

Chapter One presents an overall panorama of the present situation of youth in today's world, the importance of free game and sports in general in their development and a brief historic review of soccer. This chapter outlines some of the problems existing in sports-teaching programs for children and youth in Mexico, as well as the risks they imply. It is precisely this analysis of the methodological shortcomings of our sport at an amateur level that justifies the need to generate a system of teaching which, above all, takes good care of the children and, then, boosts the possibilities of producing high-level sports athletes.

Chapter Two describes the CFITD's mission, vision and philosophy, with the intention of making known the values underlying its existence and establishing a more direct link to the reader.

Chapter Three describes the psycho-motor characteristics of each of the categories, as well as the soccer development expected at each one of them.

Chapter Four presents the methodological considerations that were used in developing this book, the basic concepts, the methodological concepts, the sports-training goals, and the CFITD-system planning.

Chapter Five presents sports-training principles, that is, an explanation of the need to provide specialized preparation for youngsters, as well as the essential concepts for their sports training.

Chapter Six contains the CFITD teaching program for the different categories that make it up. This chapter includes planning training sessions/classes, their dosage, and description of the sessions and methods required for the training.

At the end of the book, a series of annexes expands on the information about our association, as well as the game regulations for different categories, conduct codes for parents, coaches, referees and children, dietary suggestions for young athletes, advice for the prevention and treatment of injuries, goalkeeper training, soccer tactics and an annex containing children's rights.

### The Training Program

The Training Program is structured according to the children age in seven categories. The Training Program presents the specific characteristics of each category; supports training planning for each category according to the schools program and calendar; supports annual, monthly, weekly and session dosage according to the category and training program; and provides a detailed description of each of the sessions.

The Training Program is structured in a way that systematically supports the Neuropsicomotor development of the youngster; the physic-athletic formation according with each category; the apprenticeship of the technical-tactical elements of soccer; the soccer and personal abilities development; and the healthy integration of the youngster to his environment.

Training programs are developed covering the following levels:

Category Children who, as of August 1 immediately prior to the beginning of the school year, are:

| Under-6 | Between 5 and less than 6 years old |
|---|---|
| Under-8 | Between 6 and less than 8 years old |
| Under-10 | Between 8 and less than 10 years old |
| Under-12 | Between 10 and less than 12 years old |
| Under-14 | Between 12 and less than 14 years old |
| Under-16 | Between 14 and less than 16 years old |
| 16 | 16 years old |

The structure of the workbooks for each category is the same, the difference is the dosage, ie the duration of the sessions or classes and the number of session or classes per week, month, cycle and year.

Each workbook starts with the training plan for the year, presenting the dosage and the three year training cycles merged with the school calendar.

The sports practice specifications for each category are defined in each workbook.

### Example

### Under-6 Training Program Components

As an example, the following tables show the playing specifications and Session 1 of the Under-6 training program.

### Planning Training

| | Multilateral | Preparatory | Competitive |
|---|---|---|---|
| | period | period | period |
| PHYSICAL PREPARATION | 30% | 30% | 20% |
| TECHNICAL | 40% | 40% | 50% |
| PREPARATION | | | |
| TACTICAL PREPARATION | 10% | 10% | 10% |
| PSYCHOLOGICAL | 5% | 5% | 5% |
| PREPARATION | | | |
| THEORETICAL | 15% | 15% | 15% |
| PREPARATION | | | |
| MONTHLY DURATION | 4 months | 4 months | 3 months |
| TOTAL MINUTES | 1530 | 1260 | 900 |
| TOTAL SESSIONS | 34 | 28 | 20 |

SESSION DURATION: 45′
SESSIONS A WEEK: 2
SESSIONS A MONTH: 8
SESSIONS A YEAR: 82

### Model for Planning Training

### Under-8 (6-7 Years Olds)

| | CYCLE 1 | P.T 1 | CYCLE 2 | P.T 2 | CYCLE 3 | P.T 3 | TOTAL |
|---|---|---|---|---|---|---|---|
| Multilateral period | 4 | | 3 | | 3 | | 10 |
| Preparatory period | 10 | | 8 | | 5 | | 23 |
| Competitive period | 3 | | 3 | | 2 | | 8 |
| Transition- | 1* | 2 | 1* | 2 | 7 | | 11 |
| concentration | | | | | | | |
| period* | | | | | | | |
| Week | 17 | 2 | 14 | 2 | 10 | 7 | 52 |
| Total sessions | 34 | | 28 | | 20 | | 82 |

| | |
|---|---|
| General Data | Under-6 |
| | Groups: 3v3, 4v4 |
| Category: | 5 years old |
| Sex: | Coed |
| Duration of session | 45 min |
| (minutes) | |
| Number of sessions per | 2 |
| week | |
| Total time per week | 90 min |
| Number of sessions per | 8 sessions a month |
| month | |
| Total time per month | 360 min or 6 hours a |
| | month |
| Number of games (without | One tourney a week |
| official characteristics, one | |
| at every training) | |
| Characteristics of game time | 2 equal 20-minute |
| | halves each |
| | 5 minute rest at half- |
| | time |
| Ball size | 3 |
| Number of players | Maximum 4 without |
| | goalies |
| Player equipment: gym | No more than 12 |
| shoes or soccer shoes | registered |
| with soft cleats, shin guards. | coed (boys and girls) |
| Game start: Opponents | Substitutions for |
| should be | injuries |
| 6 yards from centerfield | Everyone registered |
| mark when beginning | will play a minimum |
| | of |
| | 50%. |
| Referees: | No assistant referees |
| | needed |
| | All fouls to be |
| | explained |
| | To players. |
| Scheduling by capacity | |
| group: | |
| Conditional capacities: | 20% |
| Speed | |
| Strength | |
| Flexibility | |
| Resistance | |
| Coordinative | 25% |
| capacities: | |
| Adaptation | |
| Teamwork | |
| Differentiation | |
| Reaction | |
| Rhythm | |
| Orientation | |
| Balance | |
| Cognitive capacities; | 55%, as follows |
| Technical | 70% |
| Tactical | 10% |
| Theoretical | 10% |
| Volitive | |
| Psychological | 10% |
| TOTAL | 100% Preparation |

Characteristics of playing
field for this category:
In all cases, length exceeds
width.
Recommended: 40 × 25 yards
(36.56 × 22.86 meters)
30-40 yards (27.43 × 36.58
meters) long
(¼ of regulation field)
20-25 yards wide (18.29 ×
22.86 meters)
Distinctive lines marked,
in sidelines and goal lines,
midfield (not obligatory).
Center circle: 5-yard (4.57-
meter) radius.
4 corner arcs for corner kicks,
2 feet (0.61 meters) radius
Goal area; 3 yards (2.74
meters) from each post
To the sideline and 3 yards
(2.74 meters) inside the
playing field,
Joining a parallel line with
goal line.
Goals: Maximum: 6 feet
(1.83 meters) high and 12
feet (3.66 meters) wide
For 5v5 and 4½ feet (1.37
meters) for 9 (2.75 meters)
for 4v4.
Ball out-of-play: As per
FIFA.
Scoring goals: As per FIFA.
Off-sides: No off-sides
Fouls and misconduct: As
per FIFA,
With the following
exceptions: All fouls will be
explained
Restarted with an indirect
kick, opponents at 5 yards
(4.52 meters)
Distance. Referee should
explain fouls
To players making them.
Free kicks: As per FIFA, with
the following exceptions:
Specified under a single term
“indirect kick”.
A goal will not count if the
ball has not been
Touched by another player of
either of the two teams.
No free kicks in the goal area
Of the defending team.
Penalty kicks: No penalty
kicks.
Throw-in: substituted with a
kick-in.
The kick-in is considered an
indirect kick and the
Opponent should be 5 yards
(4.52 meters) away.
If a throw-in is used, a
second try should
Be afforded if the child doing
it wrong.
The referee should explain
the correct way of doing a
throw-in.
Goal kick: As per FIFA, with
the following exceptions:
Do it within 2 or 3 yards
(1.82-2.74 meters) from the
penalty arc.
Opponents should be 5 yards
(4.52 meters) from the ball.
Corner kicks: As per FIFA,
with the following
exceptions:
Opponents should be 5 yards
(4.52 meters) from the ball.

In Table 1 we can see that for the Under-6 training program, the duration of each session is 45 minutes, twice a week, with a technical component of 70%, 10% tactical, 10% theory and 10% psychological. Soccer is played in groups or teams of 3 or a maximum of 4 aside without goalies, in reduced areas or “fields” of 40×25 yards, with a ball size 3, everybody has to participate at least 50% of the time, all fouls and misconducts must be explained by the coach or the referee, no penalty kicks, throw in replaced by kick in, etc.

Table 2, presents Session 1 of the Under-6 training program as an example of the structure of the sessions.

### Session 1

Teaching Program Category Under-6 (5 years old)
CYCLE 1 First multilateral period
General objective: Practice coordination and individual technique
Specific objective: Practice dribbling and passing

### Observations:

In general physical preparation: Initiation to working with conditional capacities, in the following order: speed (as refers to running speed), strength, flexibility and resistance.
In special preparation: Initiation to working with coordinative capacities (adaptation, teamwork, differentiation of movement, reaction, rhythm, orientation and balance).
In technical preparation: Initiation to teaching individual technique.
In tactical preparation: Offensive principles: concept of attack; explain what an attack is and what it is for. Breadth, “play the whole field”, play easy, support.

Defensive principles: concept of defense. Explain that they should defend so they are not scored against. Attack the opponent with the ball.
In theoretical preparation: Explain the basic rules of the category, fouls and misconduct, differences with regard to the full-fledged category.

Game: 3v3, 4v4, without goalies. Everyone should participate a minimum of 50% of game time.

There should not be more than 12 students in a class.

TABLE 2
Session 1

| Phase | Activity | Description | Methodological orientation |
|---|---|---|---|
| Initial | Presentation of | Presentation of session objectives | Indications should be clear, |
| 2 minutes | the session. | by the teacher. | precise and short so children |
| | | | can understand them quickly. |
| | | | “PLAY TO HAVE FUN” |
| General | 6 minutes of | In a square 15 meter per side, one | See that during the game, |
| wrap-up | game “Tag and | player is the chaser and the other | children shift directions and |
| 8 min | Stop” | teammates those chased. The | change rhythm when running. |
| | | chaser tries to tag any of those | Play time can be shortened. |
| | | chased. The one tagged or going | Recovery exercises can be |
| | | outside the boundaries of the | done at the end of the activity. |
| | | field becomes the chaser and | |
| | | gives the one who tagged him/ | |
| | | [symbol] | |

[symbol]

indicates data missing or illegible when filed

In psychological preparation: Motivation and recreation through play.

Each session starts with the number of the session, the Category, the corresponding cycle, the general objective of the session, the specific objectives and the pertaining observations in the different education areas like:
In general physical preparation
In special preparation
In technical preparation
In tactical preparation
In theoretical preparation
In psychological preparation

The work of the session is defined in a four column table where each column describes the phase of the session with it's duration in minutes, the specific activities with it's duration in minutes, the description of the activity and finally the methodological orientation of each activity.

The phases of each session are:

Initial—Describe the session and the weekly lema
General Warm-up—with activities to prepare the body for the next physical requirements.
Special activities—activities that help in achieving the goal of the session.
Main—activities specifically designed to achieve the goal of the session.
Final—stretching activities and final comments from the coach.

The methodological orientation explains issues like the muscles involved in the activities, guides to execute the activities, the focus points of the activities, etc.

### Example

### Under-10 Training Program Components

Just as in the Under 6 example, we can see in the Under-10 session example of the Training Program that the structure is the same but the specifications, the dosage, the objectives and the activities are completely different and according to the ages involved in this category.

### Planning Training

### Under-10 (8-9 Years Old)

| | Multilateral | Preparatory | Competitive |
|---|---|---|---|
| | period | period | period |
| PHYSICAL PREPARATION | 30% | 30% | 20% |
| TECHNICAL | 40% | 40% | 50% |
| PREPARATION | | | |
| TACTICAL PREPARATION | 10% | 10% | 10% |
| PSYCHOLOGICAL | 5% | 5% | 5% |
| PREPARATION | | | |
| THEORETICAL | 15% | 15% | 15% |
| PREPARATION | | | |
| MONTHLY DURATION | 4 months | 4 months | 3 months |
| TOTAL MINUTES | 3060 | 2560 | 1800 |
| TOTAL SESSIONS | 51 | 42 | 30 |

SESSION DURATION: 60′
SESSIONS A WEEK: 3
SESSIONS A MONTH: 12
SESSIONS A YEAR: 123

### Model for Planning Training

### Under-10 (8-9 Years Old)

| | CYCLE 1 | P.T 1 | CYCLE 2 | P.T 2 | CYCLE 3 | P.T | |
|---|---|---|---|---|---|---|---|
| Multilateral period | 4 | | 3 | | 3 | | 10 |
| Preparatory period | 10 | | 8 | | 5 | | 23 |
| Competitive period | 3 | | 3 | | 2 | | 8 |
| Transition- | 1* | 2 | 1* | 2 | | 7 | 11 |
| concentration period* | | | | | | | |
| WEEKS | 17 | 2 | 14 | 2 | 10 | 7 | 52 |
| Total sessions | 51 | | 42 | | 30 | | 123 |

| | |
|---|---|
| General Data | Under-10 (8-9 years |
| | old) |
| | Group: 3v3 to 8v8 |
| Category | 8-9 years old |
| Sex: | Coed |
| Duration of session | 60 minutes |
| (minutes) | |
| Number of session per | 3 |
| week | |
| Total time per week | 180 min or 3 hours/ |
| | week |
| Number of sessions per | 12 sessions/month |
| month | |
| Total time per month | 720 min or 12 hours/ |
| | month |
| Number of games (without | One tourney a week |
| official characteristics, one | |
| at every training) | |
| Characteristics of game | 2 equal 25 min halves |
| time | each |
| | 5 min rest at halftime |
| Ball size | 4 |
| Number of players | Maximum 8 per team. |
| Player equipment: gym | No more than 18 |
| shoes or soccer shoes | registered. |
| with soft cleats, shin | Coed (boys and girls) |
| guards | Substitutions for |
| Game start: Opponents | injuries. |
| should be | Everyone registered will |
| 6 yards from centerfield | play a minimum of 50% |
| mark when beginning | |
| Referees: | No assistant referees |
| | needed. |
| | All fouls to be explained |
| | to players. |
| Scheduling by capacity | |
| group: | |
| Conditional capacities: | 60% as follows: |
| Speed | 30% |
| Strength | 10% |
| Flexibility | 10% |
| Resistance | 10% |
| Coordinative capacities: | 15% as follows: |
| Adaptation | 5% |
| Teamwork | 5% |
| Differentiation | |
| Reaction | 5% |
| Rhythm | |
| Orientation | |
| Balance | |
| Cognitive capacities: | 25% as follows: |
| Technical | 15% |
| Tactical | |
| Theoretical | 5% |
| Volitive | |
| Psychological | 5% |
| TOTAL | 100% Preparation |

Characteristics of playing field for
this category:
In all cases, length exceeds width.
Recommended: 60 × 40 yards
(54.86 × 36.58 meters),
40-70 yards (36.58 × 64 meters)
long
(½ of regulation field).
30-50 yards (27.43 × 45.72 meters)
wide
Distinctive lines marked:
sidelines and goal lines,
Midline (not obligatory).
Center circle: 8 yards (7.31 meters)
radius.
4 corner arcs, 2 feet (0.61 meters)
radius.
Goal area: 10 yards (9.144 meters)
from each post
to the sideline and 10 yards (9.144
meters) inside the playing field,
joining a parallel line with the goal
line.
Goals: maximum: 6.5 feet high and
18 feet wide
for 5v5 and 6.5 feet for 21 for 8v8.
Ball out-of-play: As per FIFA
Scoring goals: As per FIFA
Off-sides: modified
Fouls and misconduct: As per FIFA
with the following exceptions: All
fouls will be
Restarted with an indirect kick,
opponents at 6 yards.(5.48 meters)
distance for 6v6 and 8 (7.31 meters)
for 8v8. Referee should explain
fouls
To players making them.
Free kicks: As per FIFA, with the
following exceptions:
Specified under a single term
“indirect kick”.
A goal will not count if the ball has
not been touched by
another player of either of the two
teams.
No free kicks in the goal areas of
the defending team.
Penalty kicks:: No penalty kicks.
Throw-ins: with foot or hand.
If with foot, it is considered an
indirect kick and the
Opponent should be 6-8 yards
(5.48/7.31 meters) away.
If throw-in, a second try should be
afforded if the child did it
Wrong. The referee should explain
the correct way of doing a throw-in.
Goal kick: As per FIFA with the
following exceptions:
Done within 2 (1.82 meters) or 3
yards (2.74 meters) from the arc.
Opponents should be 6-8 yards
(5.48/7.31 meters) from the ball.
Corner kick: As per FIFA, with the
following exceptions:
Opponents should be 6-8 yards
(5.48-7.31 meters) from the ball.

In this example we can see that for the Under-10 training program, the duration of each session is 60 minutes, three times a week, with 60% of conditional capacities, 15% of coordinative capacities, 25% of cognitive capacities. Soccer is played in groups or teams of 3 or a maximum of 8 aside, in reduced areas or “fields” of 60×40 yards, with a ball size 4, everybody has to participate at least 50% of the time, all fouls and misconducts must be explained by the coach or the referee, no penalty kicks, throw in or kick in when the ball goes out, etc.

We also include Session 1 of the Under-10 training program as an example of the structure of the sessions.

### Session 1

Training program: Category Under-10 (8-9 years old)
CYCLE 1 First multilateral period
General objective: Develop coordination and individual technique.
Specific objective: Develop rhythmic dribbling, passing and dribbling

### Observations:

In general physical preparation: Initiation in working with conditional capacities en the following order: speed (as refers to stride frequency and stride length), strength, flexibility and resistance.
In special preparation: Continue work on coordinative capacities (adaptation, teamwork, differentiation of movement, reaction, rhythm, orientation and equilibrium).
In technical preparation: Development of individual technique.
In tactical preparation: Initiation to defensive and offensive principles.
In theoretical preparation: Teach the basic rules of the category, fouls and misconduct, differences with regard to the full-fledged category

Game: 3v3 to 8v8, with or without goalies. Everyone should participate a minimum of 50% of game time. There should not be more than 18 students in the class.
In psychological preparation: Motivation and recreation through play.

| | | | Methodological |
|---|---|---|---|
| Phase | Activity | Description | orientations |
| Initial | Presentation of | Repetition of a slogan by the group and | “THE WINNER |
| 2 minutes | the session. | presentation of the session objectives by | IS THE ONE |
| | | the trainer. | WHO GIVES |
| | | | HIS BODY AND |
| | | | SOUL TO HIS |
| | | | WORK”. |
| General | 8 minutes of | In a square 30 meters on a side, place 2 | See that the fish |
| warm-up | game “The | teams. The team members forming the | do not leave the |
| 8 minutes | Net” | “net” make a circle, 4 meters apart from | area until the |
| | | each other. The other group, the “fish,” | fishermen (“net”) |
| | | position themselves inside the net. The | have called the |
| | | players making up the net secretly | number of fish to |
| | | choose a number of fish to be caught | be caught out- |
| | | from 1-10. The fish roam around inside | loud. Fishermen |
| | | the net, while members of the net count | have 2 minutes |
| | | out-loud until reaching the number | maximum to |
| | | chosen. At that time, they try to catch the | fish. |
| | | fish and immobilize them. Any fish | |
| | | managing to get outside the square are | |
| | | safe. Each team takes two turns and the | |
| | | one catching the most fish wins. | |
| | 15 minutes of | Done in pairs, facing each other 5 meters | See that |
| | individual | apart, with a single ball. Use the width of | technical work is |
| | technique. | the midfield, sideline to sideline. | done properly. |
| | | 1. One player dribbles the ball and the | CONSTANT |
| | | other follows his/her movements. | CORRECTION. |
| | | Returning, switch roles. | |
| | | 2. Next, they do relays dribbling. The | |
| | | player In back, without the ball, moves | |
| | | ahead. | |
| | | 3. One player makes a tunnel (through | |
| | | the legs) for the other facing him/her and | |
| | | runs for the ball, stopping it and leaving | |
| | | it for the teammate who received the | |
| | | tunnel. The latter repeats the previous | |
| | | action. | |
| | | 4. One player dribbles in front of the | |
| | | other and goes after the ball, stopping it | |
| | | and leaving it for the teammate that | |
| | | dribbled, who does the same. | |
| | | 5. One player does passes forward to his/ | |
| | | her teammate, who is moving with back | |
| | | to him/her. The latter stops the ball with | |
| | | the sole of the right foot and then with | |
| | | the left. The player in front passes the | |
| | | ball. One does it going and the other | |
| | | returning. 2 minutes per exercise with 1 | |
| | | of rest. Do flexibility exercises | |
| | | inbetween. | |
| Principal | 15 minutes of | In a square 10 meters on a side, two pairs | See how the pair |
| | technical- | play. One pair has the ball and the other | with the ball |
| | tactical aspects | tries to take It away. The pair loosing the | handles it and |
| | | ball becomes the one trying to recover it. | how the other |
| | | 10 touches by a pair equals one goal. | pair recovers it. |
| | | | Constant |
| | | | mobility and |
| | | | precision. |
| 45 minutes | 15 minutes of | Number of players: 3v3 to 8v8, with or | “THE WINNER |
| | motivation, | without goalie. Everyone should play a | IS THE ONE |
| | recreation and | minimum of 50% of game time. | WHO GIVES |
| | development of | | HIS BODY AND |
| | tactical | | SOUL TO HIS |
| | thinking | | WORK”. |
| | through play. | | |
| Final | With body | Push-ups: lying face-down on all fours, | See that they are |
| | weight, | bend and extend arms upward. Sit-ups: | done according |
| | strengthen | bend knees 90° with hands on chest. | to instructions to |
| | arms, abdomen | Deep-knee bends: keep trunk upright and | avoid injuries to |
| | and legs. 2 | separate feet shoulder-width. Do 2 series | children. |
| | minutes. | of 10 repetitions. | |
| 5 minutes | 2 minutes of | With left leg forward and right leg | With a bit of |
| | flexibility | extended backward, trunk forward and | spring, change |
| | exercises. | hands on the ground, bend left knees 10 | legs. |
| | | times. 2 series. | |
| | | Sitting, legs together in front, bend and | Touch knees |
| | | lean trunk forward without bending | with forehead. |
| | | knees. 2 series of 10 repetitions. | |
| | One minute to | Session wrap-up by trainer and repetition | Trainer finishes |
| | class dismissal. | out-loud of slogan by the group. One | up by answering |
| | | minute. | doubts about |
| | | | what was seen in |
| | | | the session and |
| | | | presenting |
| | | | objectives for the |
| | | | next session, |
| | | | reciting the slogan |
| | | | with the players. |
| | | | “THE WINNER |
| | | | IS THE ONE |
| | | | WHO GIVES |
| | | | HIS BODY AND |
| | | | SOUL TO HIS |
| | | | WORK”. |

As illustrated in the examples above, the Training Program is structured in a way that systematically supports the physic-athletic formation according to each category; the apprenticeship of the technical-tactical elements of soccer; the soccer and personal abilities development; and the healthy integration of the youngster to his environment.

Each category Training Program is scheduled through the year in three stages of different length according with the category dosage, involving physical, technical, tactical, psychological training and classroom lessons, divided in multilateral, preparatory, competitive and transitional periods.

Each category Training Program has its characteristics and objectives per training subject.

Each of the sessions have a general and a specific objective with recommendations for each subject area and define minute by minute what has to be done to cover the program. Each session is divided in four phases: initial, general warming, main and final. For each phase it's defined the activity, its description and the corresponding methodological indications.

The Methodology for the Integral Training of Children and Youth 6-16 Years of Age Through Sports applies to children and youngsters of both sexes, developed with the collaboration of renowned specialists to achieve, from early age, a balanced sports work, that allows the maximum exponentiation of the physical and intellectual abilities of the young individual, without forcing his natural maturity process.

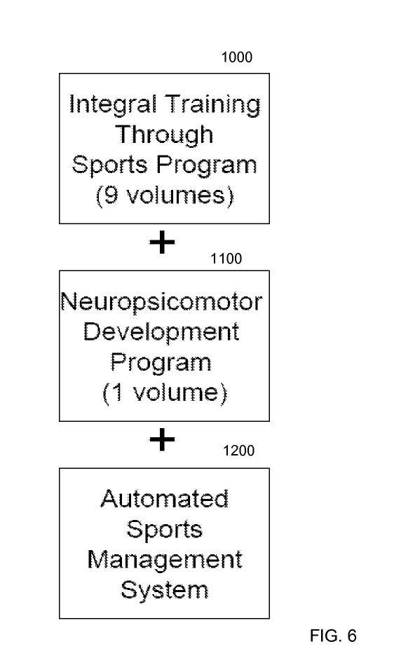

FIG. 6 is a schematic showing the methodology elements of one embodiment of the current invention. In this example, the elements include an Integral Training Through Sports Program 1000; a Neuropsicomotor Development Program 1100; and an Automated Sports Management System 1200. The methodology is integrated by these elements.

The Integral Training Through Sports Program 1000 Systematically supports Neuropsicomotor development; Physical-Athletic development according with age; Technical tactical elements of sports; Sports & personal abilities development; and Healthy integration to a player's environment.

The Neuropsicomotor Development Program 1100 establishes the underpinnings for the sports technique, academic, psychological and social development.

The Automated Sports Management System 1200 provides Information capture & process for programs evaluation and follow up.

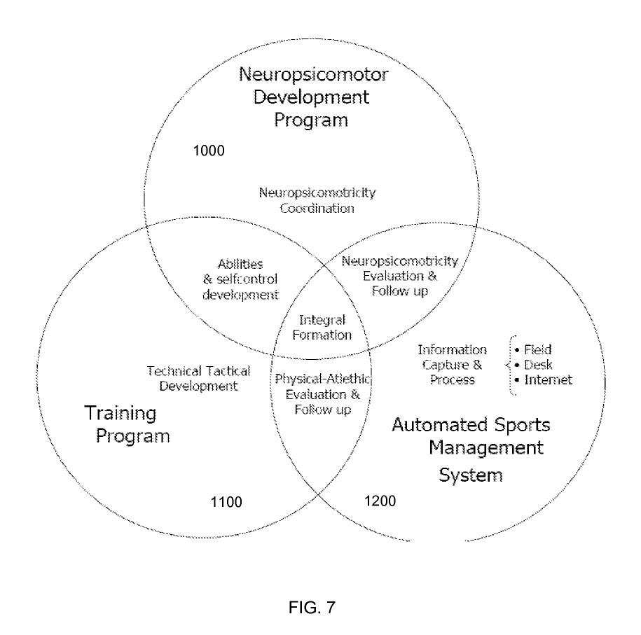

FIG. 7 is a schematic showing the interrelation of the Integral Training Through Sports Program 1000; a Neuropsicomotor Development Program 1100; and an Automated Sports Management System 1200. All of the Methodology elements are deeply interrelated and together form an integral development system.

The Methodology Impacts are reflected in the young individual as described below.

In the teaching-learning process the Methodology Impacts support mathematical notions construction; gender equity; self-care and risk prevention; ethics & values; and social participation.

In the education community the Methodology Impacts support continuous evaluation of educative programs; technological innovation & R&D; quality & coverage; ordered, structured and synthesized information; comprehensive reporting; resources optimization; support and follow up of the teacher intervention; and support and follow up of the teacher formative trajectory.

### The Neuropsicomotor Development Program

Human motricity is intimately related with the rest of human faculties: intellectual, volitive, aesthetic, etc. This is the reason why authors such as Piaget, Frostig, Maslow, Gesell, Doman, Delacato, Mc Clenaghan, Gallahue, Kepart, among others, have pointed out, on the basis of rigorous studies, the close relationship that the education of human motricity has with a person's overall development, especially underscoring intellectual and emotional maturity.

Motor activity is essential for organic-functional development. It favors emotional equilibrium and self-esteem, thanks to the favorable biochemical effects of exercise on well-being, oxygenation, sensation of mastery and happiness, itself produced by the practicing of motor activities. It favors acquiring positive habits and human values. Motor activity that exercises basic motor patterns (neuromotricity) is fundamental for the process of functional neurological organization. This occurs mainly in the first six years of life approximately. Perceptive-motor functions are developed through motor activity, which are fundamental both for the successful practice of sports as well as academic subjects.

Neuromotricity is the stimulation of the development of basic motor patterns.

The Program establishes the underpinnings for the sports technique, academic, psychological and social development. It exercises basic patterns of movement in an orderly and systematic manner, involving the propioceptivo, vestibular, sight, hearing and tactile systems. It generates new neural connections that translate in the increase and improvement of the motor functions. It expedites the apprenticeship at the sports abilities and dexterities level. The overall result will be equilibrium responses that will allow better precision.

As a global result, this program promotes the development and maturity of basic education formative fields, generating competencies that the youngsters manifest by self assurance & self confidence; clear and fluent language; analysis & synthesis capacity; self regulation; longer attention periods; hearing capacity; teamwork; tolerance; respect; ability to handle norms & limits; body consciousness; autonomy; initiative; imagination & creativity; good physical condition; and healthy body.

The Program establishes the underpinnings for the sports technique development. It exercises basic patterns of movement in an orderly and systematic manner, involving the propioceptive vestibular, sight, hearing and tactile systems. It generates new neural connections that translate in the increase and improvement of the motor and cognitive functions. It expedites the apprenticeship at the sports abilities and dexterities level. The overall result will be equilibrium responses that will allow better precision motor dexterities.

The program manual describes the general concepts, the neuropsychological fundamentals, the requirements and one chapter for the instructor and another for the student.

The structure of the program in each category covers basic patterns; antigravitational; vestibular; balance; braquiation; force; and dissociation and segmentation. The program integrates a set of exercises specifically designed for each category or age group into work sessions. There is an internal audit or evaluation for each category. The categories covered are Under6, Under8, Under10, Under12 and Under14. As in the Training Program, there is an annual, monthly, weekly and session dosage according to the category.

### Example

### Session 1 of the Under-6 Neuropsicomotor Development Program

As an example, the Session 1 of the Under-6 Neuropsicomotor Development Program is included.

| | | | |
|---|---|---|---|
| Basic Patterns | Crawling. | 10 | min. |
| | Crawling on stomach in place (fixed). | 2 | min. |
| Anti-gravitational | Jumping in place. | 2 | min. |
| Vestibular | Rolling down ramp. | 2 | min. |
| | Plain somersault on inclined plane. | 10 | rep. |
| Dynamic | Balance beam forward | 2 | min. |
| Balance | with point of fixation. | | |
| Brachiation | Two rungs of elevated horizontal ladder with help. | 2 | min. |
| | Point of fixation. | | |
| Strength | Pushing against wall, alternating hands. | 2 | min. |
| | Point of fixation and metronome. | | |
| Segmentation | 1.- Stretch waist sidewards, arms overhead | 1 | min. |
| Dissociation | 2.- Rotate both arms windmill fashion 360°. | 1 | min. |
| | 3.- Run in place raising knees as high as possible | 1 | min. |

| | |
|---|---|
| Crawling | Crawling will be done counter-laterally. When right hand advances, left |
| | leg advances at same time. When left hand advances, right leg does. |
| | Hands and legs should slide along ground without being lifted. Fingers |
| | together. Leave 20 cm between the hand and knee on the same side. |
| Crawling on stomach in | Lying face down in place, rest head to right. Right arm should go at an |
| place | angle so that eyes can fix on hand. Fingers should always go together. |
| | Left arm should bend, placing it at right angle with the hand at the height |
| | of the left shoulder. Left leg should bend at right angle and right leg |
| | extended. Shift direction without traveling. Repeat until time is over. |
| Jump in place | Jump repeatedly as high as possible in place. |
| Rolling down ramp | Students are to roll down a ramp or inclined plane, keeping arms at sides |
| | and body straight. |
| Plain somersault down | Put mat on inclined plane. Students stand at top of mat, arms extended |
| inclined plane | overhead, pushing with lower extremities. Place palms on upper end of |
| | mat on inclined plane and, head between both hands, roll downward |
| | doing the traditional somersault roll. |
| Balance beam forward | Students take small steps on beam. Keep eyes on a point of fixation, at |
| with point of fixation | eye height on a vertical plane. Keep back straight. |
| Two rungs with help. Point | Students should manage at least two rungs of horizontal ladder with |
| of fixation | instructor's help. Remember, students should be spotted (held) at waist to |
| | avoid accidents. Place sticker or mark in the middle of the rungs of the |
| | horizontal ladder. Students should stare at point of fixation at end of |
| | elevated horizontal ladder. |

### Example

### Session 1 of the Under-16 Neuropsicomotor Development Program

| | | | |
|---|---|---|---|
| Basic Patterns | Crawling, with saccades and metronome | 10 | min. |
| | (vary speed). | | |
| | Crawling on stomach in place, with | 2 | min. |
| | metronome, counting. | | |
| Anti-gravitational | Jumping to the sides, with saccades. | 2 | min. |
| Vestibular | Front somersault, with point of fixation. | 10 | reps |
| | Rolling with small and large ball. | 2 | min. |
| Dynamic | Balance beam forward and backward | 2 | min. |
| Balance | with saccades at bars, and big beanbag on head, | | |
| | with metronome. | | |
| Brachiation | Elevated horizontal ladder forward and | 2 | min. |
| | backward, with point of fixation. | | |
| Strength | Mule kick. | 2 | min. |
| Segmentation | Sitting on ground, legs extended and | 2 | min. |
| Dissociation | together. Lean forward and grab | | |
| | ankles with hands. | | |
| | Joining hands behind nape, lower an elbow and | 2 | min. |
| | stretch backward forcefully. | | |

| | |
|---|---|
| Crawling with | Crawling will be done counter-laterally. When right hand advances, |
| saccades | left leg advances at same time. When left hand advances, right leg |
| and metronome. | does. Hands and. legs slide along ground without being lifted. |
| Vary speed | Fingers together and eyes on lead hand (saccades). Leave 20 cm |
| | between hand and knee on same side. Crawling is in time with |
| | metronome, in intervals of approximately one second. Very speeds |
| | every two minutes. |
| Crawling on stomach, in | Lying face-down in place, rest head to right. Right arm should go |
| place with | at an angle so eyes can fix on hand. Fingers together. Left arm |
| metronome, counting | should bend, placing it at right angle with hand at height of left |
| | shoulder. Left leg should bend at right angle and right leg extended. |
| | Shift directions with each tick of the metronomic, without |
| | advancing, counting with each movement. |
| Hopping to sides, | Students hop turning to the right and left while keeping feet |
| with saccades | together. Place two indicator points at student eye height to |
| | alternate staring at both points. |
| Front somersault, | Students locate a point of fixation and do somersaults with legs |
| with point of fixation | together and bent. Place head on mat, supported by hands and push |
| | with legs. |
| Rolling with | Students lie on the ground face-up, arms extended overhead, |
| small and large ball | holding a small ball for the first nine sessions and a large one for |
| | the remaining ones. They roll on the ground to both sides. If they |
| | roll twice to the right, they should roll twice to the left, without |
| | lifting ball off the ground. |
| Balance beam forward and | Students take short steps on the beam with large beanbag on their |
| backward, with saccades at | head. Two bars with 5 colors each are placed approximately 3 |
| bars, and big beanbag on | meters from the student, 1.5 meters apart at eye height. Students |
| head, with metronome | stare, calling out the color of each bar with every step, in time with |
| | the metronome. Once finished, return backward and repeat. |
| Elevated horizontal ladder | Students hang from elevated horizontal ladder and, at the signal, |
| forward and backward | advance one rung and return. Repeat as many times as possible |
| without advancing, | without letting go. It is important that the instructor watch students |
| with point of fixation | at the moment they drop off the ladder to avoid accidents. Place a |
| | point of fixation at the end of the ladder. |
| Mule kick | Students are on all fours. Support body on arms and kick both feet |
| | in air, several times. |

In both examples we can se the structure of the sessions of the Neuropsicomotor Development Program. Each session is divided in two parts. The first part includes the activities and it's duration for each of the neuropsychomotor areas (Basic patterns, anti gravitational, vestibular, dynamic balance, brachiation, strength, segmentation dissociation). In the second part, each of the required activities are described in detail.

### DESCRIPTION OF EMBODIMENT

### The CFITD Techno Manager™ Automated Sports Management System

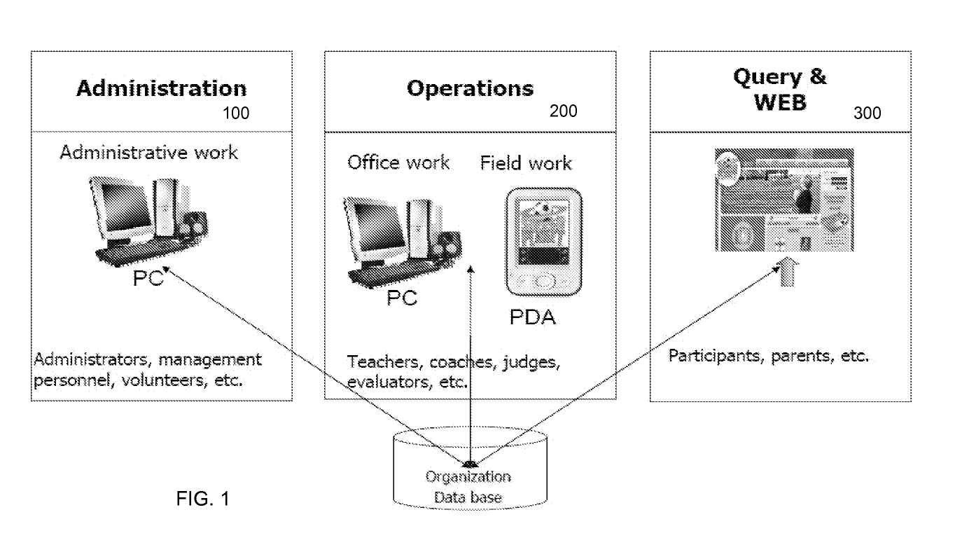

FIG. 1 is a schematic of an embodiment of the Automated Sports Management System's subsystems.

The Automated Sports Management System™ contributes to the youth sports development, through information technologies. In one embodiment, it comprises three subsystems the Administration Subsystem 100; the Operations Subsystem 200; and Query Subsystem 300

The Administration Subsystem 100 manages the control and assignment of coaches and resources, the sessions scheduling, the results presentation and statistics generation, among other functions.

The Operations Subsystem 200 automates the data entry process, supporting the coach through the use of electronics devices like PDA's (Personal Digital Assistant) or smart phone such as an iPhone™, for the initial evaluation, the attendance record and the individual follow up, aiding the sessions development or reviewing exercises graphically, the daily evaluation, among other functions.

The Query Subsystem 300 enables and expedites the report process through the access to the data base information, automatically generating reports and presentations, in the desktop or Internet modules.

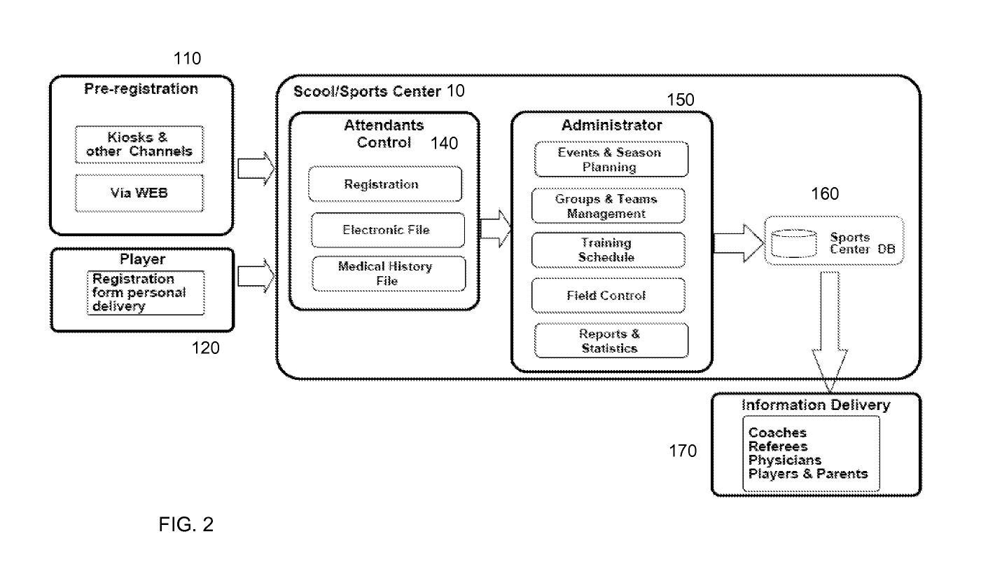

FIG. 2 is a chart showing details an embodiment of the Administration Subsystem 100 of the embodiment of the Automated Sports Management System. The Administration Subsystem comprises pre-registration 110, player registration 120; information delivery 170 to directors, coaches, referees, physicians, players, and parents; and a sports center 10 which comprises a control 140, an administrator 150, a sports center database 160, and.

The pre-registration 110 is provided through kiosks and other channels and via the WEB. Player registration 120 includes personal delivery. The control 140 comprises registration information, electronic files, and medical history files. The administrator 150 comprises events and season planning, group and teams management, training schedules, field control, and reports and statistics.

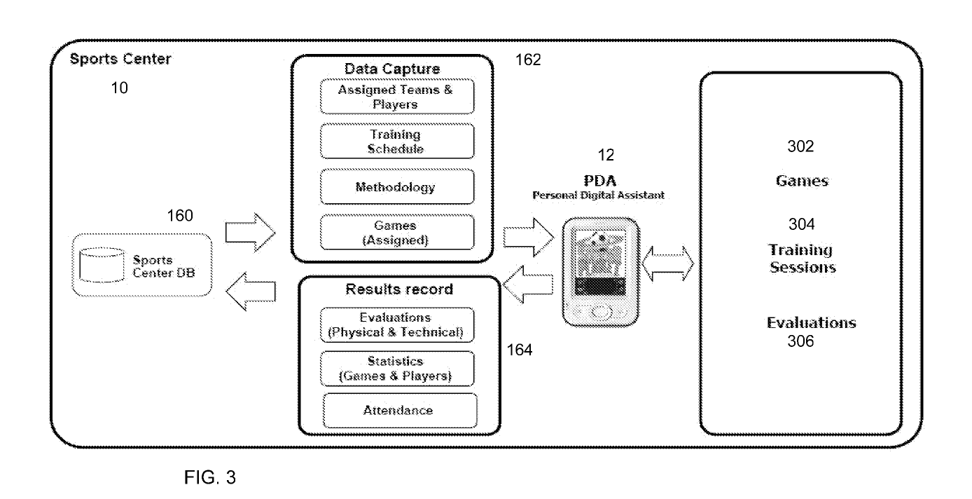

FIG. 3 is a chart showing details an embodiment of a coach's module 202 of the Operations Subsystem 200 of the embodiment of the Automated Sports Management System. In this embodiment, the sports center 10 includes the database 160 which accepts data capture 162 from assigned teams and players, training schedules, methodology, and games 302 training sessions 304; and provides results record 164 for evaluations 306, statistics, and attendance. The data may be provided from or to a mobile device such as a PDA 12.

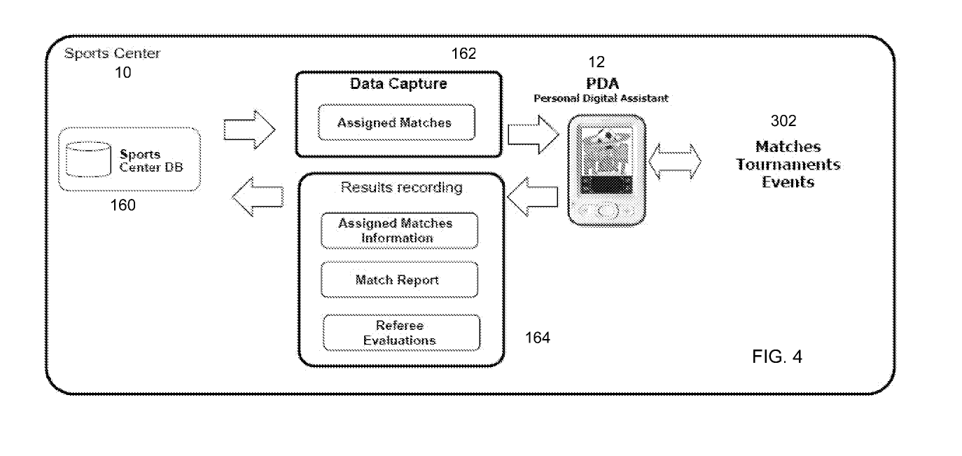

FIG. 4 is a chart showing details an embodiment of a referee's module 204 of the Operations Subsystem 200 of the embodiment of the Automated Sports Management System. In this embodiment, the sports center 10 includes the database 160 which accepts data capture 162 from assigned matches 302; and provides results record 164 for assigned matches information, match report, and referee evaluation. The data may be provided from or to a mobile device such as a PDA 12.

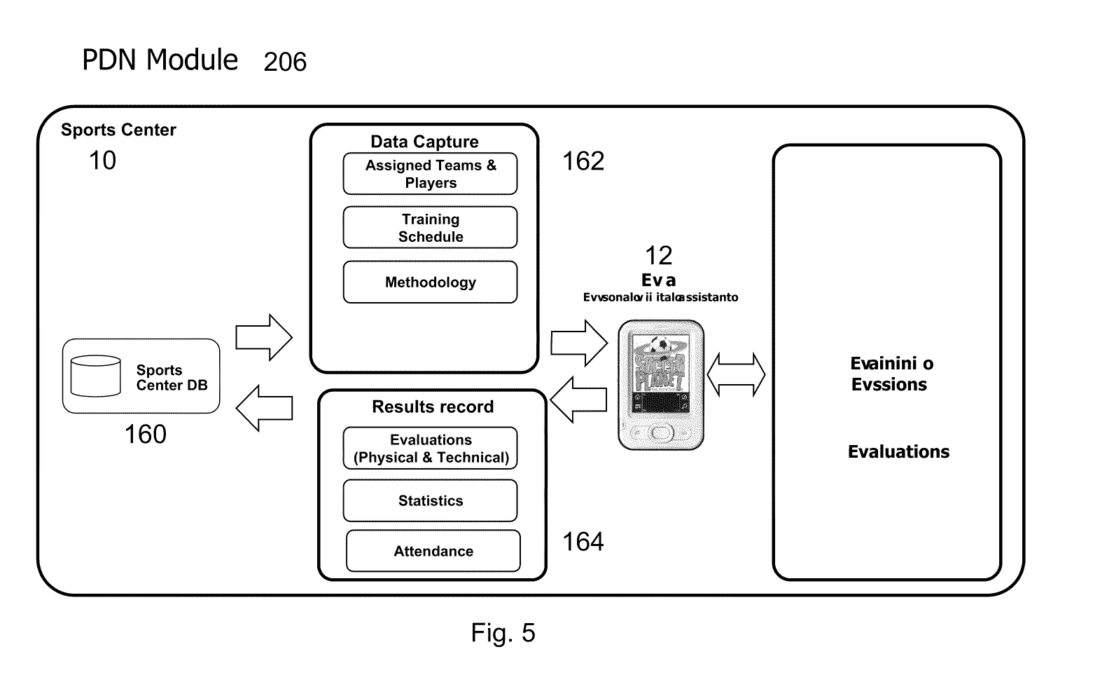

FIG. 5 is a chart showing details an embodiment of a PDN module 206 of the Operations Subsystem 200 of the embodiment of the Automated Sports Management System. In this embodiment, the sports center 10 includes the database 160 which accepts data capture 162 from assigned teams and players, training schedules, and methodology; and provides results record 164 for evaluations, statistics, and attendance. The data may be provided from or to a mobile device such as a PDA 12.

These embodiments are examples of the invention and it is evident that those skilled in the art can make variations without departing from the inventive concepts, and the invention should be limited solely by the spirit and scope of the claims.

What is claimed is:

1. A method of providing integral sports training for youth, the method comprising
providing a training program specific to the age of the youth;
providing a neuropsicomotor development program;
providing a computer-based sports management system;
providing a specific philosophy with human values, codes and behaviour rules;
and providing dietary recommendations for the youth, injury prevention and treatment, goal keeper training, and children rights.

2. The integral sports training method of claim 1 wherein
wherein the training program specific to the age of the youth, the neuropsicomotor development program, and the computer-based sports management system provide a whole and comprehensive system to teach, evaluate and follow up sports for the healthy development of the young.

3. The integral sports training method of claim 1 wherein providing a providing a training program specific to the age of the youth further comprises
providing a detailed, structured and systematized training program, with training planning, dosage, objectives and minute by minute sessions for each age category.

4. The integral sports training method of claim 1 wherein providing a neuropsicomotor development program further comprises
providing a detailed, structured and systematized neuropsicomotor development program with minute by minute sessions for each age category.

5. The integral sports training method of claim 1 wherein providing computer-based sports management system further comprises
providing a computer-based administration subsystem to manage the control and assignment of coaches and resources, training sessions scheduling, and results presentation and statistics generation;
a computer-based operations subsystem to the data entry process, supporting the coach through the use of mobile devices for the initial evaluation, the attendance record and the individual follow up, aiding the sessions development or reviewing exercises graphically, the daily evaluation, and other functions; and
a web-based query subsystem to enable and expedite the report process through the access to the data base information, automatically generating reports and presentations.

6. A computer implemented method of sports management comprising
providing a sports management system comprising
a computer-based administration subsystem to manage the control and assignment of coaches and resources, training sessions scheduling, results presentation and statistics generation,
a computer-based operations subsystem to the data entry process, supporting the coach through the use of mobile field devices for the initial evaluation, the attendance record and the individual follow up, aiding the sessions development or reviewing exercises graphically, the daily evaluation, and other functions, and
a web-based query subsystem to enable and expedite the report process through the access to the data base information, automatically generating reports and presentations;
using the sports management system for player registration, administration, coaching data, and referee data.

7. The method of claim 6 wherein using the sports management system for player registration further comprises
providing a web-based player registration for data input and communication of registration information, electronic files, and medical history files.

8. The method of claim 6 wherein using the sports management system for administration further comprises
providing an administrator for events and season planning, group and teams management, training schedules, field control, and reports and statistics.

9. The method of claim 6 wherein using the sports management system for coaching data comprises
providing a coach's module for field data capture and data communication with a plurality of mobile devices, for data related to assigned teams and players, training schedules, methodology, games and training sessions, evaluations, statistics, and attendance records.

10. The method of claim 6 wherein using the sports management system for referee data comprises
providing a referee's module which accepts field data capture with a plurality of mobile devices, from assigned matches; and provides results record for assigned matches information, match report, and referee evaluation.

11. A sports management system comprising
a first computer which hosts an administration subsystem to manage the control and assignment of coaches and resources, training sessions scheduling, results presentation and statistics generation, the administration subsystem comprising
preregistration functions,
information delivery functions, and
a sports center comprising
a control,
an administrative function, and
a sports center database;
an operations subsystem comprising
operations software on the first computer, and
a plurality of mobile field devices in communication with the administration subsystem;
a web-based query subsystem comprising
sports center database access functions, and
report generation and presentation functions.

12. The sports management system of claim 11 wherein
the operations subsystem automates data entry processes, and supports coaches through the use of mobile field devices for initial evaluation, attendance record and individual follow up, aiding the sessions development or reviewing exercises graphically, and daily evaluation.

13. The sports management system of claim 11 wherein
the web-based query subsystem enables and expedites the report process through the access to data base information, automatically generating reports and presentations, in desktop computer or Internet modules.

14. The sports management system of claim 11 wherein the plurality of mobile field devices further comprise
personal digital assistants or smart phones.

15. The sports management system of claim 11 wherein the information delivery functions further comprise
web-based communication information delivery to directors, coaches, referees, physicians, players, and parents.

16. The sports management system of claim 11 wherein
the preregistration functions are provided at a plurality of web-based registration kiosks.
